(19) United States
(12) Patent Application Publication
(10) Pub. No.: US 2017/0328994 A1
(43) Pub. Date: Nov. 16, 2017

(54) RADAR SYSTEM

(71) Applicant: NIDEC ELESYS CORPORATION, Kawasaki-shi (JP)

(72) Inventor: Akira ABE, Kawasaki-shi (JP)

(21) Appl. No.: 15/487,572

(22) Filed: Apr. 14, 2017

(30) Foreign Application Priority Data
May 16, 2016 (JP) 2016-098251
Apr. 6, 2017 (JP) 2017-075861

(51) Int. Cl. G01S 13/42; H01Q 3/38

(52) U.S. Cl. CPC G01S 13/426; H01Q 3/38

(57) ABSTRACT

A wide angle of a range of a field of view of a radar is handled with a wider reception interval. There is provided a radar system which converts a reception signal into digital data using a receiving array to perform sensing through arithmetic processing, the radar system including: the receiving array composed of three or more receiving systems; and at least two transmitting antennas having directional properties each of which is in horizontal symmetry and which are different in beam width, wherein the transmitting antennas different in directional property alternately perform transmissions, and a region of an arrival wave is determined based on a difference in measurement between reception levels corresponding to the individual transmissions. Defining a range in which a measurement of a propagation path length difference between adjacent receiving systems is less than a half-wavelength as a main region and outsides thereof as outside regions, in the case of the arrival wave from the outside regions, the arrival wave is determined to be from the outside region on a horizontally opposite side to a measured orientation to calculate an orientation in accordance with relation between an angle measurement value and an arrival angle in the outside region. Thereby, an angle range within which a sensing coinciding with the arrival angle is obtained is expandable from a conventional main region to a range within which the measurement of the propagation path length difference between the adjacent receiving systems is less than one wavelength.

### CROSS REFERENCE TO RELATED APPLICATIONS

This application claims the benefit of priority to Japanese Patent Application No. 2016-098251 filed on May 16, 2016 and Japanese Patent Application No. 2017-075861 filed on Apr. 6, 2017. The entire contents of each application are hereby incorporated herein by reference.

### BACKGROUND OF THE INVENTION

### 1. Field of the Invention

The present invention relates to an orientation sensing scheme especially for handling a wide angle of a digital beam forming (DBF) radar in an on-vehicle millimeter-wave radar monitoring the travelling direction of a vehicle.

### 2. Description of the Related Art

DBF radars generically refer to radars which include a receiving array composed of a plurality of receiving systems arranged to line up at predetermined intervals (generally, at the same intervals) in a scanning direction, and sense the position of a target through conversion of reception signals from the receiving systems into digital data and arithmetic processing thereof. As orientation sensing (angle measuring method), a technique of directly detecting the orientation such as monopulse angle measurement, and a high-resolution sensing scheme such as a MUltiple SIgnal Classification (MUSIC) method can also be applied other than the DBF method which performs beam scanning in the equivalent phased array scheme. It is the mainstream in on-vehicle millimeter-wave radars because of capability of high-speed and high-precision scanning without a requirement for drive components or movable mechanisms.

As to early on-vehicle radars, their main purpose was front monitoring in travelling on an expressway or the like. In a DBF radar, as the reception interval (arrangement interval in the scanning direction) is wider, higher resolution can be obtained. Moreover, since the width of the receiving antenna can also be wider, the antenna gain can be more enhanced and longer-range monitoring can be performed. Meanwhile, since the sensible angle range is conversely narrowed down, it is advantageous in terms of performance to select as wide the reception interval as possible within the condition under which the monitoring range can be secured. As the reception interval for the monitoring range, about two wavelengths are selected for 0±10° and about one wavelength is selected for 0±20° approximately. In order to prevent an arrival wave outside the monitoring range from undergoing erroneous sensing as an arrival wave within the monitoring range, there are contrived various measures such as a method of suppressing the antenna gain to be low at outward angles. When a plurality of transmissions can be used, Japanese Patent No. 5930590 by way of example discloses a method of determining, using transmissions different in directional property, erroneous sensing based on a difference in measurement between corresponding reception levels.

A wide angle (wide range of a field of view in the horizontal direction) is recently being requested in order to monitor the right and the left at an intersection, crossing pedestrians and the like as well as proceeding vehicles ahead. To this end, it is needed to narrow an interval P of a receiving array in a conventional orientation sensing scheme. For example, P<0.65λ is the necessary condition in the case where the range of the field of view is about 0±50°. λ is a free-space wavelength and λ=3.92 mm at 76.5 GHz used for an on-vehicle millimeter-wave radar. However, such a narrow interval causes restriction and disadvantage to the antennas. In the case of mounting in a vehicle room, it is difficult to compose vertical polarization antennas suitable for transmission through glass. Even in the case other than mounting in a vehicle room, if the reception interval is largely less than 1λ, cross-coupling interference between the receiving antennas exceedingly increases, and deterioration of sensing precision and the like are concerned. As mentioned above, the larger the reception interval is, the more advantageous the radar performance is. Accordingly, there is desired an orientation sensing scheme capable of handling a wide angle even for as wide a reception interval as possible.

### SUMMARY OF THE INVENTION

There is provided a radar system which transmits an electric wave and receives a reflected wave to detect a position of a target, the radar system including a DBF radar that converts a reception signal into digital data to perform sensing through arithmetic processing, the DBF radar including: a receiving array composed of three or more receiving systems; and at least two transmitting antennas having directional properties each of which is in horizontal symmetry and which are different in beam width, wherein the transmitting antennas different in directional property alternately perform transmissions, the DBF radar has a function of determining a region of an arrival wave based on a difference in measurement between reception levels corresponding to the individual transmissions, and defining a range in which a measurement of a propagation path length difference between adjacent receptions is less than a half-wavelength as a main region and outsides thereof as outside regions, in the case of the arrival wave from the outside regions, the arrival wave is determined to be from the outside region on a horizontally opposite side to a measured orientation, and by calculating an orientation based on a relational expression of Expression 11, an angle range within which a sensing coinciding with an arrival orientation is obtained is expandable from a conventional main region to a range within which the measurement of the propagation path length difference between the adjacent receiving systems is less than one wavelength.

A wide angle can be handled with an about twice wider reception interval than in a conventional angle measuring method.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a view of a radar system of the present invention as seen from the Z-direction.

FIG. 1B is a cross-sectional view of the radar system of the present invention as seen from the X-direction.

FIG. 1C is a cross-sectional view of the radar system of the present invention as seen from the Y-direction.

FIG. 2 is a radiation property of the radar system of the present invention.

FIG. 3 is a sensing property of a conventional radar system.

FIG. 4 is a sensing property of the radar system of the present invention.

FIG. 5 is a sensing property of the radar system of the present invention in a boundary region.

FIG. 6 shows a principle of angle measurement.

### DETAILED DESCRIPTION OF THE PREFERRED EMBODIMENTS

A DBF radar generally senses an arrival angle of a reflected wave in each distance range under proper division into the distance ranges to specify the position (distance and orientation) of a target. As to an on-vehicle radar which needs low costs and downsizing, a problem to be solved is to handle separation and sensing of parallelly travelling vehicles and road-side objects with as less number of constituents of the receiving array as possible. Therefore, various sensing schemes in which the number of arrival waves in a distance range is suppressed by fine division into distance ranges and which are suitable for separation of further more arrival waves and high resolution are used.

Any of such various sensing schemes basically takes the following principle of angle measurement based on a phase difference. First, only one arrival wave is supposed within a focused distance range, and in this case, simple expressions can be shown. A case of a plurality of arrival waves is mentioned later.

In FIG. 6, a plurality of receiving systems R0, R1, R2, . . . are arranged to line up at the same intervals P in a scanning direction (horizontal direction for an on-vehicle radar), and constitute a receiving array. While in each receiving system, a receiver and an analog/digital signal converter are connected to an antenna, this figure only shows arrangement relation of the antennas. A coordination system is defined in which the horizontal direction is the X-axis and the orthogonal direction to the opening surfaces of the antennas is the Z-axis, and the XZ-plane is the scanning plane. Defining an elongation from the Z-axis in the horizontal direction as θ, this figure shows the right side by a positive value (+) and the left side by a negative value (−).

As to an arrival wave from a θ-direction, a propagation path length difference of ρ arises between incidences to adjacent receiving systems, and a phase difference φo proportional to ρ arises between reception waves. φo uniquely corresponds to an arrival angle θ, and is defined as the “true value” of the phase difference. k is a wavenumber (=2π/λ).

ρ=P·sin θ Expression 1

φo=k·ρ Expression 2

Defining an orientation sensing value (sensing angle) as θ, when the true value of the phase difference is obtained, a sensing coinciding with the arrival angle (hereinafter, referred to as intended sensing) is obtained based on Expression 3.

θ=sin⁻¹{φo/(kP)}=θ Expression 3

The phase angle measuring method is based on this principle, a phase difference φ is measured using the receiving array to calculate the sensing angle based on Expression 4.

θ=sin⁻¹{(φ/(kP)} Expression 4

The measured phase difference φ is obtained through complex calculation from reception data, and calculated as a value of |φ|≦π.

Therefore, φ is given based on Expression 5, and does not necessarily coincide with φo.

φ=φo+ι·2π=kP·sin θ+ι·2π Expression 5

ι is an integer (0, ±1, . . . ) that minimizes the absolute value of φ.

Defining an arrival angle with ρ=λ/2 as χ, a range in which |θ|<χ, accordingly, |ρ|<λ/2 is referred to as a main region, and outsides thereof are referred to as outside regions.

χ=sin⁻¹{λ/(2P)} Expression 6

In the main region, ι=0, accordingly, φ=φo, and the intended sensing is obtained.

Defining a field of view (azimuthal angle range which is the monitoring target) of the radar as 0±Ω, in order to obtain an intended sensing within the field of view, the setting χ>Ω is needed as the lower limit, and the condition for the reception interval P is shown below.

P<λ/(2·sin Ω) Expression 7

Namely, a wide field of view needs a narrow reception interval accordingly, and, for example, P<0.65λ in the case of Ω=50°.

On the contrary, in a design example of the present invention, a reception interval P=1.13λ can handle Ω=50°.

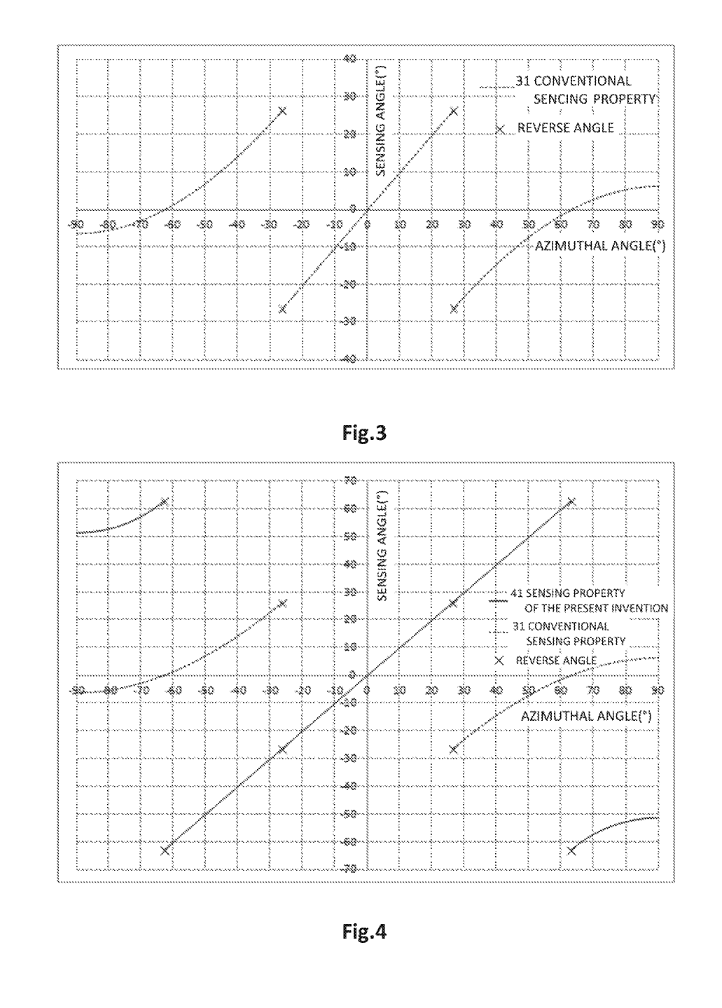

Precedingly, dotted lines 31 in FIG. 3 show a sensing property in a corresponding conventional phase angle measuring method with P=4.4 mm at 76.5 GHz. χ=26.45° based on Expression 6, while θ=θ within the range of the arrival angle θ with |θ|<χ, calculation is performed to be θ≈−χ+δ at θ=×+δ where θ slightly exceeds χ and to be θ≈+χ−δ at θ=−(χ+δ), and the positive/negative (right/left) of the detection angle is reversed at the boundaries of θ=±χ. The angles at which such a phenomenon arises are referred to as reverse angles, which are indicated by x marks in the figure. In Expression 5, the ι value corresponds to the arrival region, ι=0 at |θ|<χ, ι=−1 at θ>χ, and ι=+1 at θ<−χ.

The present invention expands the sensing range by determining the arrival region (any of |θ|<χ, θ>χ and θ<−χ). When the region is specified, the intended sensing can be obtained even in the outside region by restoring the true value of the phase difference using the corresponding ι value. Solid lines 41 in FIG. 4 show the orientation sensing property. With P=4.4 mm, the same as in FIG. 3, the aforementioned conventional angle measuring property 31 (dotted lines) is also shown. It is determined based on a reception level from which of the main/outside regions the arrival wave has come. Details of the determination technique are mentioned later. The sensing angle according to the present invention is indicated by θe. In the case of the main region, θe=θ=θ by using the conventional angle measurement value. In the outside regions, determination of the right side or the left side is further needed. Herein, in the property 31, corresponding relation between the region of θ and the positive/negative of θ is confirmed. In the right-side outside region (θ>χ), the phase difference φ is given by Expression 7, taking a negative value at ρ<λ and a positive value at ρ>λ.

φ=2πρ/λ−2π Expression 7

Herein, the azimuthal angle at which ρ=λ is defined as χe. With 76.5 GHz and P=4.4 mm, χe=63°.

χe=sin⁻¹{λ/P} Expression 8

Ranges of χ<|θ|<χe, accordingly, λ/2<|ρ|<λ are referred to as lateral regions.

The positives/negatives of φ and θ coincide with each other. In the right-side lateral region, θ<0, and at θ>χe, θ>0. The sensing property is in odd symmetry to θ. In the left-side lateral region, θ>0, and at θ<−χe, θ<0. Focusing on the lateral regions, the case of θ<0 corresponds to the right side (θ>χ, ι=−1), and the case of θ>0 corresponds to the left side (θ<−χ, ι=+1). Based on this, in the present invention, a correction phase difference in Expression 9 is defined, and in Expression 4, φ is replaced by it.

φe=φ−ιe·2π Expression 9

In the case of θ<0, ιe=−1 is given, and in the case of θ>0, ιe=+1 is given. Notably, the main region corresponds to ιe=0.

Thereby, φe=φo even in the lateral regions, and as shown in the figure, the intended sensing range is expanded up to 0±χe, which is about twice wider than conventional 0±χ. Accordingly, a wide angle can be handled with the substantially twice larger reception interval than in the conventional angle measuring method. Notably, expression and expansion for θe calculation are shown below.

θe=sin⁻¹{φe/(kP)}=sin⁻¹{(φ−ιe·2π)/(kP)} Expression 10

Expression 11 is derived using relations in Expression 4 and Expression 8. Namely, direct calculation from the θ value is also possible.

θe=sin⁻¹{sin θ−ιe·sin χe} Expression 11

In the present invention, θ=±χe are the reverse angles. The condition under which erroneous sensing does not arise even in the regions of |θ|>×e, which are outside the intended sensing range, is given with respect to θe by Expression 12. Thereby, a sensing value with respect to an arrival wave from the outside of the field of view is |θe|>Ω, and can be removed as being outside the monitoring target.

|θe(θ=±π/2)|>Ω Expression 12

Expression 13 is derived from this, and P=1.13λ above with respect to Ω=50° is calculated.

P<2λ/(1+sin Ω) Expression 13

Notably, if the arrival wave level can be sufficiently suppressed to be low in the regions of |θ|>χe by means of the angle directional property of the antennas or the similar property, the condition in Expression 13 is not necessarily used, but P can be further widen or Ω can be further expanded.

While the description so far is made based on the phase angle measuring method, the present invention can be applied generally to orientation sensing schemes using a receiving array and also to cases of a plurality of arrival waves. For example, in DBF, a direction in which a reception signal becomes strong is obtained by equivalent beam scanning, and also with respect to the plurality of arrival waves, their orientations θd and reception levels are individually analyzed as corresponding detection values. Also in other sensing schemes, orientations and reception levels corresponding to the individual arrival waves are equivalently detected while there are differences in performance such as precision therebetween.

Herein, between the case where the orientation of an arrival wave is in the outside region θg and the case where it is in the main region θm given by Expression 14, the regions cannot be discriminated from each other in terms of complex reception data, but for both, θd=θm is detected.

θm=sin⁻¹{sin θg+ι·λ/P} Expression 14

This precisely shows the property in FIG. 3, and the relation of θd with respect to the arrival angle θ is the same as in the conventional phase angle measuring method regardless of the number of the arrival waves and the sensing scheme. Accordingly, the expansion of the sensing range in the present invention can be applicable as it is. Namely, the to value is specified by means of determination of the main/outside regions for each detection value based on the reception level and determination of the right or the left based on the positive or the negative of θd in the outside regions, and the intended sensing can be obtained within the range of 0±χe based on Expression 11.

Next, determination of the main/outside regions based on the reception level is described.

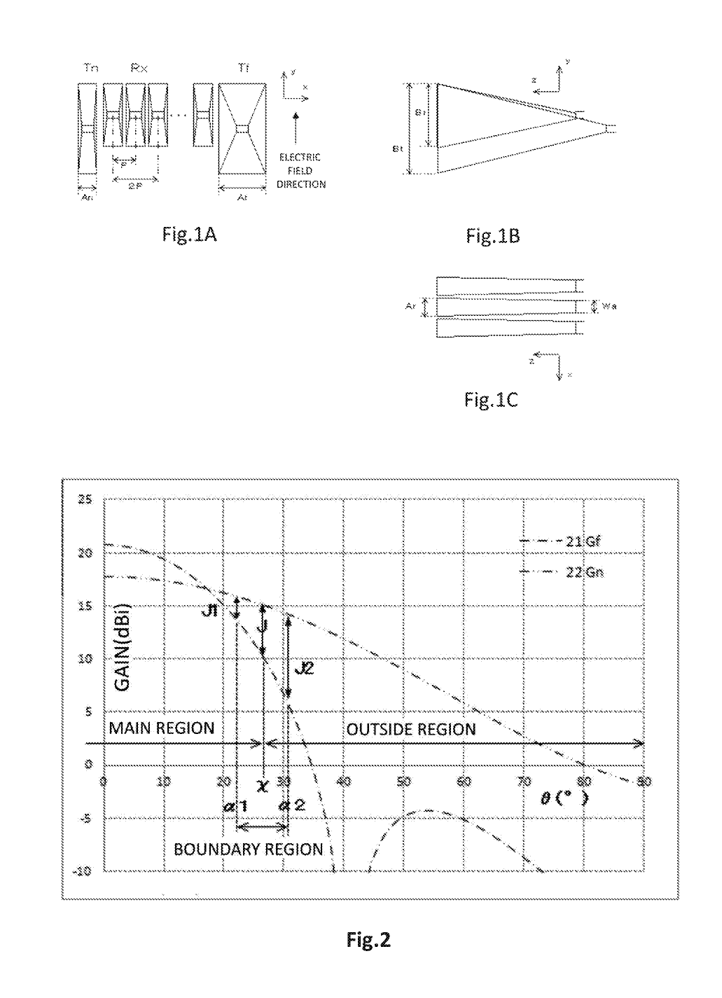

FIGS. 1A to 1C exemplarily show a radar antenna corresponding to an application of the present invention. FIG. 1A is an elevation view (XY-plane) as seen from the opening side. FIG. 1B is a vertical cross-sectional view (YZ-plane). FIG. 1C is a horizontal cross-sectional view (XZ-plane). Each antenna handles a vertically polarized wave. A receiving array is constituted of three or more receiving antennas, which are arranged at the same intervals P in the horizontal direction. Moreover, two (or more) transmitting antennas Tf and Tn are included, which have different beam properties from each other. Tf has a narrow beam width but a high gain in the front direction, and is mainly used for monitoring at a front long distance. Tn has a low front gain but a wide beam width, and is used for wide monitoring at a short distance. Such a configuration and usage are generally employed. While rectangular horns are used as the radiators, herein supposing their mounting in a vehicle room, the type of the antenna is not specially limited.

FIG. 2 shows a design example of a radiation property. Each antenna is mechanically in horizontal symmetry, accordingly, its radiation property is also regarded as being in horizontal symmetry, and only the right half is shown. Dot-and-dash lines 21 and a long dashed double-short dashed line 22 respectively show directional gains Gf(θ) and Gn(θ) of Tf and Tn. They are calculation values, supposing that the horizontal widths of the openings are Af=9 mm for Tf and An=4.5 mm for Tn, both of the vertical widths thereof are Bt=20 mm, and the depths thereof are sufficiently long. Supposing that the outputs of the transmitters are the same, a level ratio D corresponding to the gain ratio of transmissions appears on reception waves from the same reflection target with respect to the different transmissions. With a gain ratio J at θ=χ being as a reference value, determination can be performed to be the main region in the case of D>J and to be the outside region in the case of D<J. Gf, Gn, D and J are given using dB values as follows.

D(θ)=Gf(θ)−Gn(θ), J=Gf(χ)−Gn(χ)

J is a fixed value defined by design values of the antennas, measurements thereof or the like, and when there is a difference between the transmitter outputs, J is defined by further correcting it.

Although the intended sensing range can be expanded as above, there are still some problems against completely continuous sensing across the range of the field of view. At θ=χ (and −χ), θe=±χ both are the solutions of Expression 4, and namely, the right and the left cannot be discriminated from each other at these orientations. Moreover, although the reference value J is defined to be a fixed value, the level ratio D has a fluctuation element. For example, even when the output of the transmitter/receiver slightly fluctuates, determination of the main/lateral regions is mistaken, and the right or the left of the sensing value is reversed. In order to solve these, there can be considered a measure to provide two sets of receiving arrays different in reception interval and to complement them by performing sensing using one of them in the vicinity of the reverse angle of the other of them. Nevertheless, such increase in configuration is not suitable for an on-vehicle radar which needs low costs and downsizing.

In the present invention, discontinuity and erroneous sensing are prevented by the following technique. A receiving array with the twice larger reception interval is focused on as one in which arrangements different in reception interval are achieved without increase in configuration.

In this case, the reverse angles due to the phase angle measuring method appear as follows. The values for P=1.13λ are shown in the parentheses.

χb1=sin⁻¹{λ/(4P)}(=12.87°) Expression 15

χb2=sin⁻¹{3λ/(4P)}(=41.93°) Expression 16

A phase difference φb and an auxiliary value θb corresponding to the angle measurement value are given in conformity to the phase angle measuring method within a range of χb1<θ<χb2 by Expression 17 and Expression 18. Notably, since they are in odd symmetry to θ, only the right side (θ>0) is tentatively shown.

φb=2kP·sin θ−2π Expression 17

θb=sin⁻¹{φb/(2kP)} Expression 18

Although θb does not directly give the arrival angle, it uniquely corresponds to the arrival angle when the arrival region is specified.

Expanding Expression 17 and Expression 18,

Expression 19 is derived.

sin θb=sin θ−sin(π/kP)=sin θ−sin χ Expression 19

For determining the arrival region, defining χb1>α1>χ>α2>χb2, a boundary region is provided in a range of α1<|θ|<α2 sandwiching χ as shown in FIG. 2. For determining the region, the reception level ratio is used similarly to the aforementioned determination of the main/outside regions. With J1=Gf(α1)−Gn(α1) and J2=Gf(α2)−Gn(α2) being as reference values anew, the boundary region is determined when J1>D(θ)>J2. By defining them such that D(χb1)>J1>D(χ)>J2>D(χb2) in consideration of level fluctuation in transmission and reception and the like, the arrival angle of the arrival wave that is determined to be from the boundary region is specified to be within a range of ×b1<|θ|<×b2.

With respect to the arrival wave from the boundary region, the following sensing processing is performed. Using alternately corresponding data in the receiving array out of the acquired reception data, that is, with the twice larger reception interval under the same conditions of the arrival wave, the auxiliary value θb is calculated in conformity to the measurement angle. From Expression 19, the intended sensing is obtained based on the relational expression of Expression 20, and moreover, further simpler approximation can be applied.

θe=sin⁻¹{sin θb+sin χ}≈b+χ Expression 20

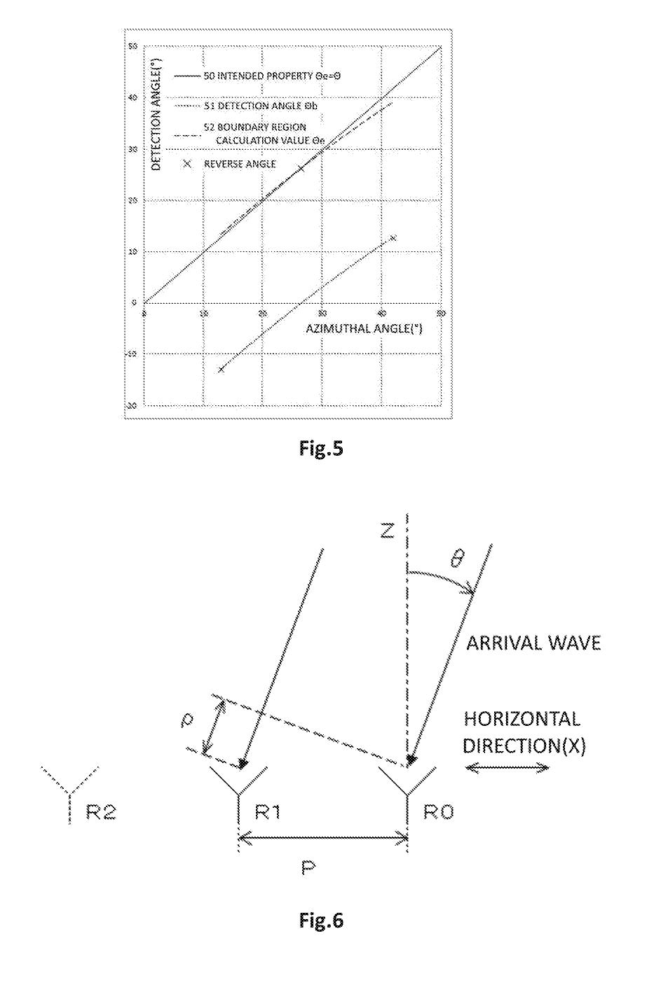

FIG. 5 shows a sensing property for this. A thin solid line 50 shows the intended property at θe=θ, a dotted line 51 shows the detection value of θb based on Expression 18, and a broken line 52 shows a calculation value through approximation, which substantially coincides with the intended property. Note that the right or the left cannot be determined from the detection value of θb itself. For this, since the arrival wave does not appear only in the boundary region but continuously moves thereinto from the main region or the lateral region, the right or left direction (sign) the same as that of the immediately previous sensing value θp is applied. For θp<0, Expression 21 is employed in place of Expression 20.

θe=sin⁻¹{sin θb−sin χ}≈θb−χ Expression 21

As above, without a requirement for addition or modification of the configuration, orientation sensing can be continuously performed within the field of view. Continuous sensing is important for monitoring in order to trace a target and to catch its movements such as coming close and going away, and a slight error thereof does not cause any problem. Even using the approximation, an error with respect to the intended property within the range of χb1<|θ|<χb2 is 5% or less.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A radar system which transmits an electric wave and receives a reflected wave to detect a position of a target, the radar system comprising
a DBF radar that converts a reception signal into digital data to perform sensing through arithmetic processing, the DBF radar including:
a receiving array composed of three or more receiving systems; and at least two transmitting antennas having directional properties each of which is in horizontal symmetry and which are different in beam width, wherein
the transmitting antennas different in directional property the DBF radar has a function of determining a region of an arrival wave based on a difference in measurement between reception levels corresponding to the individual transmissions, and
defining a range in which a measurement of a propagation path length difference between adjacent receptions is less than a half-wavelength as a main region and outsides thereof as outside regions, in the case of the arrival wave from the outside regions, the arrival wave is determined to be from the outside region on a horizontally opposite side to a measured orientation, and by calculating an orientation based on a relational expression of Expression 11, an angle range within which a sensing coinciding with an arrival orientation is obtained is expandable from a conventional main region to a range within which the measurement of the propagation path length difference between the adjacent receiving systems is less than one wavelength.

2. The radar system according to claim 1, wherein
in the function of determining the region of the arrival wave,
a ratio of a gain of a second transmitting antenna relative to a gain of a first transmitting antenna in an orientation of a boundary between the regions to be determined is defined as a reference value, the first transmitting antenna having a directional property narrower in beam width than the second transmitting antenna, and
the region is determined to be inside a boundary orientation when a ratio of a reception level corresponding to a transmission from the second transmitting antenna relative to a reception level corresponding to a transmission from the first transmitting antenna is larger than the reference value, and determined to be outside when the ratio is smaller than the reference value.

3. The radar system according to claim 1, wherein
configuring a boundary region to sandwich an orientation of a boundary between the main region and the outside region, in the case of the arrival wave from the boundary region through region determination based on reception levels corresponding to the individual transmissions from the transmitting antennas different in directional property, an auxiliary value is calculated in conformity to a measurement angle using alternately corresponding data in the receiving array out of reception data, that is, with the twice larger reception interval under the same condition of the arrival wave, as to a right side or a left side, determination is made to be the same side as that of an immediately previous sensing value, and
by calculating a sensing value based on a relational expression or an approximation expression of Expression 20 or Expression 21, discontinuity and erroneous sensing in the vicinity of the boundary between the main region and the outside region are prevented.
